(19) United States
(12) Patent Application Publication
(10) Pub. No.: US 2007/0279362 A1
(43) Pub. Date: Dec. 6, 2007

(54) Liquid crystal display device and driving method of the same

(75) Inventor: Wei Wang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/810,404

(22) Filed: Jun. 4, 2007

(30) Foreign Application Priority Data
Jun. 2, 2006 (TW) 95119605

(51) Int. Cl. G09G 3/36

(52) U.S. Cl. 345/99

(57) ABSTRACT

An exemplary liquid crystal display device (3) includes: a liquid crystal panel (31) including a plurality of pixel units; a printed circuit board (32) including a V_{com} modulating circuit (321); and a timing controller (322). The timing controller includes a gray scale voltage modulating circuit (3221), the V_{com} modulating circuit is configured for modulating common voltage of the plurality of pixel units, and the gray scale voltage modulating circuit is configured for further modulating gray scale voltages of the plurality of pixel units. A related method for driving the liquid crystal display device is also provided.

### FIELD OF THE INVENTION

The present invention relates to a liquid crystal display device configured for reducing image flicker and a related method for driving the liquid crystal display device.

### BACKGROUND

A liquid crystal display device has the advantages of portability, low power consumption, and low radiation, and has been widely used in various portable information products such as notebooks, personal digital assistants (PDAs), video cameras and the likes. However, the liquid crystal display device is prone to exhibit image flicker. This is usually due to an electrical feedthrough effect, which induces an offset effect on data voltages applied to pixel electrodes of the liquid crystal display device.

FIG. 4 is a block diagram of a conventional liquid crystal display device configured for reducing image flicker. The liquid crystal display device 1 includes a liquid crystal panel 11, a printed circuit board 12, and a flexible printed circuit board 13. The liquid crystal panel 11 includes a V_{com} (common voltage) transfer pad 111. The printed circuit board 12 includes a V_{com} modulating circuit 121 and a timing controller 122. The V_{com} transfer pad 111 is electrically coupled to the V_{com} modulating circuit 121 via the flexible printed circuit board 13. The timing controller 122 provides gray scale voltage signals and controlling signals to drive the liquid crystal panel 11 to display images. The V_{com} modulating circuit 121 transmits a voltage signal to compensate a common voltage of the liquid crystal panel 11, thereby reducing image flicker of the liquid crystal panel 11.

Feedthrough effects generated in different areas of the liquid crystal panel 11 are different from each other. For convenient description, an array of pixel units of the liquid crystal panel 11 is divided into five portions, as shown in FIG. 4. Table 1 below illustrates how to reduce image flicker, using a 127th gray level as an example. When the liquid crystal display device 1 displays a positive frame image and each portion of the liquid crystal panel 11 displays the 127th gray level, the timing controller 122 provides the 127th gray level voltage to the pixel units of each portion of the liquid crystal panel 11. Due to the feedthrough effects, unadjusted gray levels displayed on the five portions would be slightly offset from the 127th gray level. The V_{com} modulating circuit 121 transmits the voltage signal to compensate the common voltage of the third portion, and thereby ensures the pixel units in the third portion display the exact predetermined 127th gray level. However, the other four portions are still offset from the predetermined 127th gray level, as shown in table 1. When the liquid crystal display device 1 displays a negative frame image, the situation is similar to that described above in relation to the displaying of a positive frame image. Overall, the liquid crystal display device 1 cannot totally solve the problem of image flicker.

TABLE 1

| | portion of the liquid crystal panel 11 | first | second | third | fourth | fifth |
|---|---|---|---|---|---|---|
| positive | the gray level to be displayed | 127 | 127 | 127 | 127 | 127 |
| frame | the gray level actually displayed | 125 | 126 | 127 | 128 | 129 |
| image | | | | | | |
| negative | the gray level to be displayed | 127 | 127 | 127 | 127 | 127 |
| frame | the gray level actually displayed | 129 | 128 | 127 | 126 | 125 |
| image | | | | | | |

FIG. 5 is a block diagram of another conventional liquid crystal display device configured for reducing image flicker. The liquid crystal display device 2 includes a liquid crystal panel 21. For convenient description, an array of pixel units of the liquid crystal panel 21 is divided into five portions according to different feedthrough effects. Each portion of the five portions includes a V_{com} transfer pad 211. A printed circuit board 22 includes five V_{com} modulating circuits 221 and a timing controller 222. Each V_{com} transfer pad 211 is electrically coupled to a corresponding V_{com} modulating circuit 221 via a respective flexible printed circuit board 23.

When an image displayed on the liquid crystal panel 21 flickers, the five V_{com} modulating circuits 221 transmits voltage signals to compensate the common voltages of the corresponding portions. The level of voltage signals transmitted is dependent on the extent of image flicker in each portion. Thereby, image flicker of the liquid crystal panel 21 as a whole is reduced.

However, the liquid crystal display device 2 needs to have numerous V_{com} modulating circuits 221 installed on the printed circuit board 22. Each V_{com} modulating circuit 221 must be electrically coupled to a corresponding V_{com} transfer pad 211 on the liquid crystal panel 21. This makes the overall configuration of circuitry of the liquid crystal display device 2 unduly complicated and the cost of the liquid crystal display device 2 correspondingly high.

What is needed, therefore, is a liquid crystal display device that can overcome the above-described deficiencies.

### SUMMARY

An aspect of the invention relates to a liquid crystal display device including a liquid crystal panel having a plurality of pixel units; and a printed circuit board including a V_{com} modulating circuit and a timing controller; wherein the timing controller includes a gray scale voltage modulating circuit. The V_{com} modulating circuit is configured for modulating a common voltage of the plurality of pixel units, and the gray scale voltage modulating circuit is configured for further modulating gray scale voltages of the plurality of pixel units.

A further aspect relates to a method for driving a liquid crystal display device, including: providing a liquid crystal panel having an array of pixel units and a printed circuit board including a V_{com} modulating circuit and a timing controller, the timing controller includes a gray scale voltage modulating circuit; dividing the array of pixel units into a plurality of portions; modulating a common voltage of the pixel units of the portions by the V_{com} modulating circuit; modulating gray scale voltages of the pixel units of the portions by the gray scale voltage modulating circuit; and displaying an image on the liquid crystal panel according to the modulated common voltage and the modulated gray scale voltages.

Other novel features and advantages will become more apparent from the following detailed description when taken in conjunction with the accompanying drawings.

### BRIEF DESCRIPTION OF THE DRAWINGS

FIG. 1 is a block diagram of a liquid crystal display device for reducing image flicker according to a preferred embodiment of the present invention.

FIG. 2 is essentially an abbreviated circuit diagram of a liquid crystal pane of the liquid crystal display device of FIG. 1.

FIG. 3 is a block diagram of a timing controller of the liquid crystal display device of FIG. 1.

FIG. 4 is a block diagram of a conventional liquid crystal display device configured for reducing image flicker.

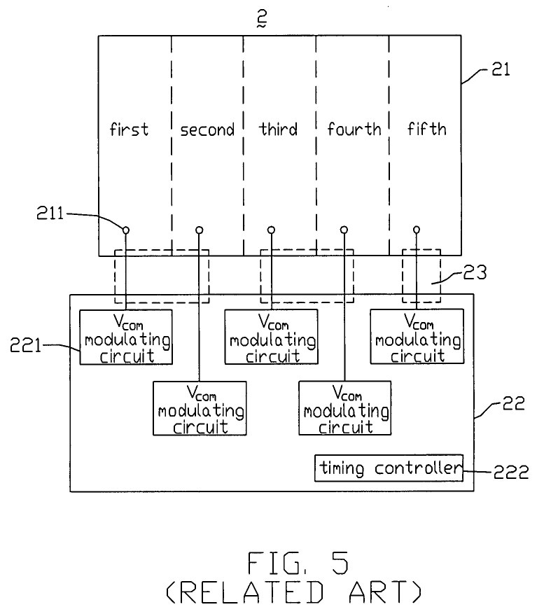

FIG. 5 is a block diagram of another conventional liquid crystal display device configured for reducing image flicker.

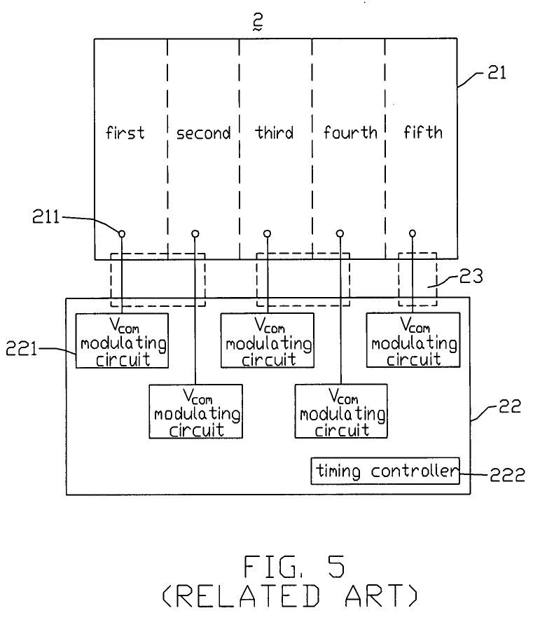

### DETAILED DESCRIPTION OF PREFERRED EMBODIMENTS

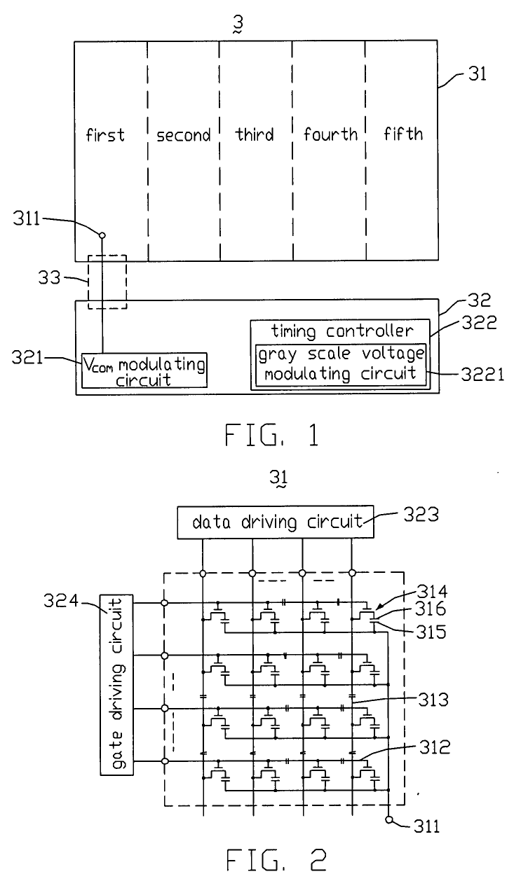

FIG. 1 is a block diagram of a liquid crystal display device for reducing image flicker according to a preferred embodiment of the present invention. The liquid crystal display device 3 includes a liquid crystal panel 31, a printed circuit board 32, and a flexible printed circuit board 33.

The liquid crystal panel 31 includes a V_{com} transfer pad 311. The printed circuit board 32 includes a V_{com} modulating circuit 321 and a timing controller 322. The timing controller 322 includes a gray scale voltage modulating circuit 3221. The V_{com} modulating circuit 321 is electrically coupled to the V_{com} transfer pad 311 via the flexible printed circuit board 33.

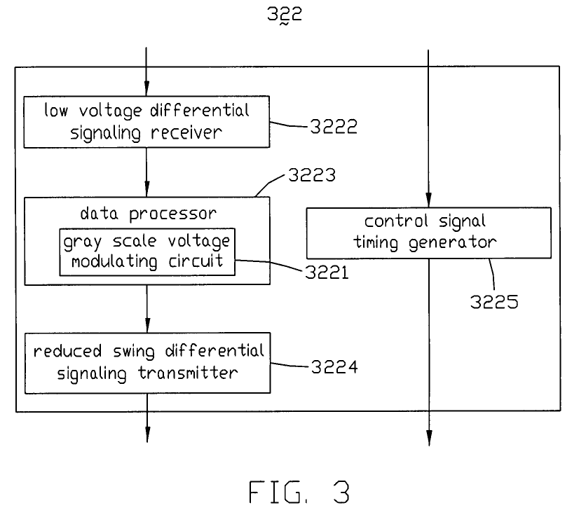

FIG. 2 is essentially an abbreviated circuit diagram of the liquid crystal panel 31. The liquid crystal panel 31 includes a data driving circuit 323, a gate driving circuit 324, a plurality of gate lines 312 that are parallel to each other, a plurality of data lines 313 that are parallel to each other, a plurality of thin film transistors (TFTs) 314 that function as switching elements, a plurality of pixel electrodes 316, and a plurality of common electrodes 315. The gate lines 312 and data lines 313 cross each other, thereby defining an array of pixel units. Each pixel unit includes a respective TFT 314, a respective pixel electrode 316, and a respective common electrode 315. Each TFT 314 is provided in the vicinity of a respective point of intersection of the gate lines 312 and the data lines 313, and is electrically coupled to a respective common electrode 315. The common electrodes 315 are electrically coupled to the V_{com} transfer pad 311. The gate driving circuit 324 is used to drive the gate lines 312. The data driving circuit 323 is used to drive the data lines 313.

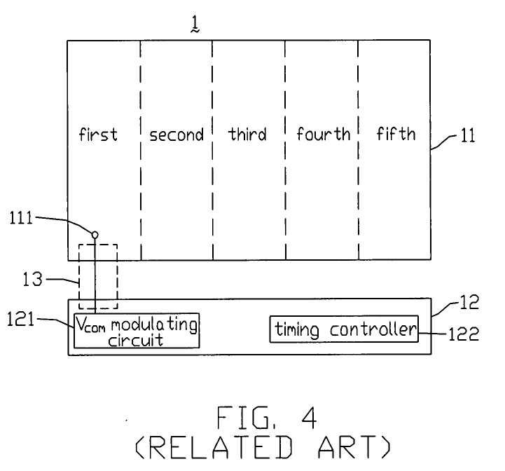

FIG. 3 is a block diagram of the timing controller 322. The timing controller 322 includes a low voltage differential signaling receiver 3222, a data processor 3223, a reduced swing differential signal transmitter 3224, and a control signal timing generator 3225. The gray scale voltage modulating circuit 3221 is disposed in the data processor 3223. The low voltage differential signaling receiver 3222, the data processor 3223, and reduced swing differential signal transmitter 3224 are electrically connected in series.

The low voltage differential signaling receiver 3222 receives a low voltage differential signal from an outside circuit, and transmits the low voltage differential signal to the data processor 3223. The data processor 3223 and the gray scale voltage modulating circuit 3221 process the low voltage differential signal, convert the low voltage differential signal to a reduced swing differential signal, and then transmit the reduced swing differential signal to the reduced swing differential signal transmitter 3224. The reduced swing differential signal transmitter 3224 transmits the reduced swing differential signal to the data driving circuit 323. The control signal timing generator 3225 receives a controlling signal from an outside circuit, and processes the controlling signal, and then transmits the controlling signal to the gate driving circuit 324. The data driving circuit 323 and the gate driving circuit 324 receive and process the respective signals received, and drive the pixel units of the liquid crystal panel 31 to display images.

The array of pixel units of the liquid crystal panel 31 is divided into a plurality of portions, according to different feedthrough effects. The feedthrough effects are approximately uniform in any one portion. The number of pixel units in each portion may be the same. Alternatively, the number of pixel units in any two or more of the portions may be different. For convenient description, the pixel units of the liquid crystal panel 31 are divided into five portions. The five portions are strip-shaped, and are oriented parallel to the data lines 313, as shown in FIG. 1.

Referring to table 2 below, this uses a 127th gray level as an example, for the purposes of illustrating operation of the liquid crystal display device 3. When the liquid crystal display device 3 displays a positive frame image, generally speaking, if the timing controller 322 and the data driving circuit 323 provide the 127th gray level voltage to the pixel units of each portion of the liquid crystal panel 31, then the liquid crystal panel 31 would display the 127th gray level. However, due to the feedthrough effects, the gray scale voltages applied to the pixel units of the five portions would progressively increase from the first portion to the fifth portion. In order to reduce image flicker induced by the feedthrough effects, the liquid crystal display device 3 operates as follows. First, the V_{com} modulating circuit 321 transmits a voltage signal to compensate the common voltage of the five portions to make the center portion, namely the third portion, display the exact predetermined 127th gray level. Then, the gray scale voltage modulating circuit 3221 provides progressively decreasing (degressive) voltage signals to the five portions, from the first portion to the fifth portion in that order. Following this, the gray levels actually displayed in the five portions are converted to the 127th gray level. Thus each portion of the liquid crystal panel 31 displays substantially the exact predetermined 127th gray level, and image flicker is reduced.

TABLE 2

| | portion of the liquid crystal panel 31 | first | second | third | fourth | fifth |
|---|---|---|---|---|---|---|
| positive | the gray level to be displayed | 127 | 127 | 127 | 127 | 127 |
| frame | the gray scale voltage provided | 129 | 128 | 127 | 126 | 125 |
| image | the gray level actually displayed | 127 | 127 | 127 | 127 | 127 |
| negative | the gray level to be displayed | 127 | 127 | 127 | 127 | 127 |
| frame | the gray scale voltage provided | 125 | 126 | 127 | 128 | 129 |
| image | the gray level actually displayed | 127 | 127 | 127 | 127 | 127 |

When the liquid crystal display device 3 displays a negative frame image, due to the feedthrough effects, the degressive gray scale voltages are applied to the pixel units of the five portions from the first portion to the fifth portion in that order. In particular, in order to reduce image flicker induced by the feedthrough effects, the liquid crystal display device 3 operates as follows. First, the V_{com} modulating circuit 321 transmits a voltage signal to compensate the common voltage of the five portions to make the center portion, namely the third portion, display the exact predetermined 127th gray level. Then the gray scale voltage modulating circuit 3221 provides progressively increasing voltage signals to the portions from the first portion to the fifth portion in that order. Following this, the gray scales actually displayed in the five portions are converted to the 127th gray level. Thus each portion of the liquid crystal panel 31 displays substantially the exact predetermined 127th gray level, and image flicker is reduced.

In summary, the liquid crystal display device 3 only requires the V_{com} modulating circuit 321 to be installed on the printed circuit board 32, and the gray scale voltage modulating circuit 3221 to be provided in the timing controller 322. This makes the overall configuration of circuitry of the liquid crystal display device 3 relatively simple, and the cost of the liquid crystal display device 3 corresponding low. Further, the array of pixel units of the liquid crystal panel 31 can be divided into fewer than five portions or more than five portions, with the gray scale voltage modulating circuit 3221 being configured correspondingly. Thereby, image flicker can be reduced more simply and inexpensively, and/or reduced even more effectively.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display device, comprising:
a liquid crystal panel comprising a plurality of pixel units; and
a printed circuit board comprising a V_{com} modulating circuit and a timing controller;
wherein the timing controller comprises a gray scale voltage modulating circuit, the V_{com} modulating circuit is configured for modulating a common voltage of the plurality of pixel units, and the gray scale voltage modulating circuit is configured for further modulating gray scale voltages of the plurality of pixel units.

2. The liquid crystal display device as claimed in claim 1, further comprising a V_{com} transfer pad and a flexible printed circuit board, wherein the V_{com} modulating circuit is electrically coupled to the V_{com} transfer pad via the flexible printed circuit board.

3. The liquid crystal display device as claimed in claim 1, wherein the timing controller comprises a low voltage differential signaling receiver, a data processor, and a reduced swing differential signal transmitter, which are electrically coupled in series.

4. The liquid crystal display device as claimed in claim 3, wherein the timing controller further comprises a control signal timing generator.

5. The liquid crystal display device as claimed in claim 3, wherein the gray scale voltage modulating circuit is provided in the data processor.

6. The liquid crystal display device as claimed in claim 1, wherein the pixel units of the liquid crystal panel are arranged in an array, and the array of pixel units is divided into a plurality of portions according to different feedthrough effects.

7. The liquid crystal display device as claimed in claim 6, wherein the number of pixel units in each portion of the pixel units is the same.

8. The liquid crystal display device as claimed in claim 6, wherein the number of pixel units in any two or more of the portions of the pixel units is different.

9. A method for driving a liquid crystal display device to display an image, the image having reduced or no image flicker, the method comprising:
providing a liquid crystal panel comprising an array of pixel units and a printed circuit board comprising a V_{com} modulating circuit and a timing controller, the timing controller comprising a gray scale voltage modulating circuit;
dividing the array of pixel units into a plurality of portions;
modulating a common voltage of the pixel units of the portions by the V_{com} modulating circuit;
modulating gray scale voltages of the pixel units of the portions by the gray scale voltage modulating circuit; and
displaying an image on the liquid crystal panel according to the modulated common voltage and the modulated gray scale voltages.

10. The method as claimed in claim 9, wherein the liquid crystal panel comprises a plurality of data lines, and each of the plurality of portions of the array of pixel units is strip-shaped, and is oriented parallel to the data lines.

11. The method as claimed in claim 10, wherein the V_{com} modulating circuit transmits a voltage signal to compensate a common voltage of a center portion of the plurality of portions, such that the center portion displays a predetermined gray level.

12. The method as claimed in claim 11, wherein the gray scale voltage modulating circuit operates as follows:
when the liquid crystal display device displays a positive frame image, the gray scale voltage modulating circuit provides progressively decreasing gray scale voltages to the pixel units of each of the portions, and provides the a predetermined gray scale voltage to the pixel units of the center portion; and
when the liquid crystal display device displays a negative frame image, the gray scale voltage modulating circuit provides progressively increasing gray scale voltages to the pixel units of each of the portions, and provides the predetermined gray scale voltage to the pixel units of the center portion.

13. The method as claimed in claim 10, wherein the number of pixel units in each portion of the pixel units is the same.

14. The method as claimed in claim 10, wherein the number of pixel units in any two or more of the portions of the pixel units is different.

15. The method as claimed in claim 10, wherein the number of portions of the pixel units is five.
